(19) United States
(12) Patent Application Publication
(10) Pub. No.: US 2016/0266353 A1
(43) Pub. Date: Sep. 15, 2016

(54) Camera Lens

(71) Applicants: Hiroyuki Teraoka, Kyoto (JP); Jianming Wang, Shenzhen (CN)

(72) Inventors: Hiroyuki Teraoka, Kyoto (JP); Jianming Wang, Shenzhen (CN)

(73) Assignees: AAC Acoustic Technologies (Shenzhen) Co.,Ltd., Shenzhen (CN); AAC Technologies Japan R&D Center, Kyoto (JP)

(21) Appl. No.: 15/001,764

(22) Filed: Jan. 20, 2016

(30) Foreign Application Priority Data
Mar. 13, 2015 (JP) 2015-051146

(51) Int. Cl. G02B 13/00; G02B 27/00; G02B 9/60

(52) U.S. Cl. CPC G02B 13/0045; G02B 9/60; G02B 27/0025

(57) ABSTRACT

The present invention discloses a camera lens including, lined up in turn from the object side: a stop, a first lens with positive refractive power, a second lens with negative refractive power, a third lens with negative refractive power, a fourth lens with positive refractive power, a fifth lens with negative refractive power. The camera lens satisfies the following conditions: 0.70≦f1/f≦0.78, −1.90≦f2/f≦−1.30, −400.00≦f3/f≦−65.00, −1.20≦(R1+R2)/(R1−R2)≦−1.00, 1.20≦(R7+R8)/(R7−R8)≦1.90, 0.08≦d6/f≧0.13.

### FIELD OF THE DISCLOSURE

The present invention discloses camera lenses, and more particularly to a camera lens used in a mobile phone, a WEB camera etc. equipped with high-pixel CCD, CMOS and camera elements.

### BACKGROUND

In recent years, a variety of cameras equipped with CCD, CMOS or other camera elements are widely popular. Along with the development of miniature and high performance camera elements, the ultrathin and high-luminous flux F wide-angle camera lens with excellent optical characteristics is needed in market.

The technology related to the camera lens composed of 5 ultrathin and high-luminous flux f wide angle lenses with excellent optical properties is developed gradually. The camera lens mentioned in the proposal is composed of 5 lenses which are lined up in turn from the object side as follows: a first lens with positive refractive power, a second lens with negative refractive power, a third lens with negative refractive power, a fourth lens with positive refractive power, a fifth lens with negative refractive power.

The camera lens in the embodiment 4 to 6 in the special bulletin No.2014-197105 is composed of 5 lenses described above, but the distribution of the refractive power of the first lens, the second lens and the third lens, as well as the shape of the fourth lens are inadequate. Fno≧2.64, 2ω≦65.0° wide angle is not sufficient and Fno luminous flux are insufficient.

The camera lens described in the embodiments 1-5 of JP patent publication No. 2014-197104 is composed of 5 lenses described above, but the refractive power of the first lens and the shape of the fourth lens are inadequate. The degree of wide angle 2 Ω≦71.4° is inadequate.

For this reason, it is necessary to provide a novel camera lens to overcome the shortcomings above.

### BRIEF DESCRIPTION OF THE DRAWINGS

Many aspects of the embodiments can be better understood with reference to the following drawings. The components in the drawing are not necessarily drawn to scale, the emphasis instead being placed upon clearly illustrating the principles of the present disclosure. Moreover, in the drawings, like reference numerals designate corresponding parts throughout the several views.

FIG. 1 is a structural diagram of a camera lens LA related to an embodiment of the present disclosure.

FIG. 2 is a structural diagram of a camera lens in accordance with a first exemplary embodiment (embodiment 1) of the present disclosure.

FIG. 3 is a diagram of the longitudinal aberration of the camera lens LA in embodiment 1.

FIG. 4 is a diagram of the Lateral Color of the camera lens LA in embodiment 1.

FIG. 5 is a diagram of the field curvature and distortion of the camera lens LA in embodiment 1.

FIG. 6 is a structural diagram of a camera lens LA in accordance with a second exemplary embodiment (embodiment 2) of the present disclosure.

FIG. 7 is a diagram of the longitudinal aberration of camera lens LA of embodiment 2.

FIG. 8 is a diagram of Lateral Color of the camera lens LA in embodiment 2.

FIG. 9 is a diagram of the field curvature and distortion of the camera lens LA in embodiment 2.

FIG. 10 is a structural diagram of a camera lens LA in accordance with a third embodiment (embodiment 3) of the present disclosure.

FIG. 11 is a diagram of the longitudinal aberration of camera lens LA in embodiment 3.

FIG. 12 is a diagram of Lateral Color of the camera lens LA in embodiment 3.

FIG. 13 is a diagram of the field curvature and distortion of the camera lens LA in embodiment 3.

### DETAILED DESCRIPTION

The present disclosure will be described in detail below with reference to the attached drawings and exemplary embodiments thereof.

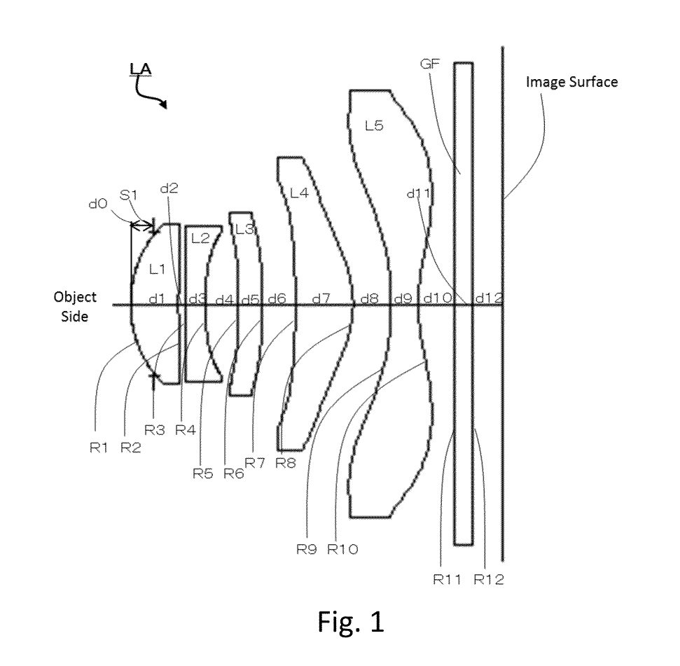

FIG. 1 is an illustrative structure of a camera lens of one embodiment of the present invention. The camera lens LA comprises 5 lenses which are lined up in turn from the object side to the image side as follows: a stop S1, a first lens L1, a second lens L2, a third lens L3, a fourth lens L4 and a fifth lens L5. A glass plate GF is provided between the fifth lens L5 and the imaging plane. The glass plate GF is a cover glass or a light filter with IR cut-off filtration and other functions, or alternatively, the glass plate GF is not provided between the fifth lens L5 and the imaging plane.

The first lens L1 has positive refractive power. The second lens L2 has negative refractive power. The third lens L3 has negative refractive power. The fourth lens L4 has positive refractive power. The fifth lens L5 has negative refractive power. In order to correct aberration better, the surface of 5 lenses is designed to be non-spherical shape.

The camera lens LA satisfies the following conditions (1)-(6):

0.70≦=f1/f≦0.78 (1)

−1.90≦f2/f≦−1.30 (2)

−400.00≦f3/f≦−65.00 (3)

−1.20≦(R1+R2)/(R1−R2)≦−1.00 (4)

1.20≦(R7+R8)/(R7−R8)≦1.90 (5)

0.08≦d6/f≦0.13 (6)

In which:
f: Overall focal distance of the lenses.
f1: The focal distance of the first lens.
f2: The focal distance of the second lens.
f3: The focal distance of the third lens.
R1: The curvature radius of the object side of the first lens.
R2: The curvature radius of the image side of the first lens.
R7: The curvature radius of the object side of the fourth lens.
R8: The curvature radius of the image side of the fourth lens.
d6: The axial distance from the image side of the third lens to the object side of the fourth lens.

The condition (1) specifies the positive refractive power of the first lens L1. When exceeding the lower limit of the condition (1), the first lens L1 has too great positive refractive power to correct the aberration and other issues and also not conducive to wide-angle development of lens. On the contrary, when exceeding the upper limit, the first lens has too weak refractive power to realize the ultrathin target of lens.

The condition (2) specifies the negative refractive power of the second lens L2. If the value exceeds the limit of the condition (2), along with the wide angle and ultrathin development of the lens, it is difficult to correct the axial and abaxial chromatic aberration.

The condition (3) specifies the negative refractive power of the third lens L3. If the value exceeds the limit of the condition (3), along with the wide angle and ultrathin development of the lens, it is difficult to correct the axial and abaxial chromatic aberration.

The condition (4) specifies the shape of the first lens L1. If the value exceeds the limit of the condition (4), along with the wide angle and ultrathin development of the lens, it is difficult to correct the spherical aberration and other higher aberration issues.

The condition (5) specifies the shape of the fourth lens L4. By satisfying the condition (5), the wide angle and ultrathin development of the lens is effective.

The condition (6) specifies the proportion of the distance between the image side of the third lens L3 and the object side of the fourth lens L4 to the overall focus distance of the lenses. If the value exceeds the limit of the condition (6), it is not conducive to the wide angle and ultrathin development of the lens.

The camera lens further meets the following condition (7):

0.07≦d8/f≦0.15 (7)

In which:
f: Overall focal distance of the lenses.
d8: The axial distance from the image side of the fourth lens to the object side of the fifth lens.

The condition (7) specifies the proportion of the distance between the image side of the fourth lens L4 and the object side of the fifth lens to the overall focus distance of the lenses. If the value exceeds the limit the condition (7), it is not conducive to the wide angle and ultrathin development of the lenses.

The fourth lens L4 has positive refractive power and satisfies following condition (8):

0.50≦f4/f≦0.80 (8)

In which:
f: Overall focal distance of the lenses
f4: The focal distance of the fourth lens.

The condition (8) specifies the positive refractive power of the fourth lens L4. By satisfying the condition (8), the lens can realize the wide angle and ultrathin development target.

The fifth lens L5 has negative refractive power and satisfies the following condition (9):

˜0.80≦f5/f≦˜0.45 (9)

In which:
f: Overall focal distance of the lenses.
f5: The focal distance of the fifth lens.

The condition (9) specifies the negative refractive power of the fifth lens L5. By satisfying the condition (9), the lens can realize wide-angle and ultrathin target and can ensure the axial distance from the image side to the imaging plane of the fifth lens.

As five lenses of the camera lens LA have the composition described above and meet all conditions, it is possible to produce a camera lens composed of 5 ultrathin and high-luminous flux lenses with excellent optical properties, TTL (optical length)/IH (image height)≦1.35, wide angle 2ω≧74°, Fno≦2.2.

### Embodiments

Embodiments will be described in detail. All the symbols in the drawings and described in the embodiments are described and explained as follows.

f: The overall focal distance of the camera lens LA.
f1: The focal distance of the first lens L1.
f2: The focal distance of the second lens L2.
f3: The focal distance of the third lens L3.
f4: The focal distance of the fourth lens L4.
f5: The focal distance of the fifth lens L5.
Fno: F value.
2ω: full view angle.

### S1: Stop.

R: Curvature radius of image side, Center curvature radius of the lens.
R1: The curvature radius of the object side of the first lens L1.
R2: The curvature radius of the image side of the first lens L1.
R3: The curvature radius of the object side of the second lens L2.
R4: The image side curvature radius of the second lens L2.
R5: The curvature radius of the object side of the third lens L3.
R6: The curvature radius of the image side of third lens L3.
R7: The curvature radius of the object side of the fourth lens L4.
R8: The curvature radius of the image side of the fourth lens L4.
R9: The curvature radius of the object side of the fifth lens L5.
R10: The curvature radius of the image side of the fifth lens L5.
R11: The object side curvature radius of the glass plate GF.
R12: The curvature radius of the image side of the glass plate GF.
d: Center thickness of lenses and the distance between lenses.
d0: Axial distance from the stop S1 to the object side of the first lens L1.
d1: The center thickness of the first lens L1.
d2: The distance from the image side of the first lens L1 to the object side of the second lens L2.
d3: The center thickness of the second lens L2.
d4: The axial distance from the image side of the second lens L2 to the object side of the third lens L3.
d5: The center thickness of the third lens L3.
d6: The axial distance from the image side of the third lens L3 to the object side of the fourth lens L4.
d7: The center thickness of the fourth lens L4.
d8: The axial distance from the image side of the fourth lens L4 to the object side of the fifth lens L5.
d9: The center thickness of the fifth lens L5.
d10: The axial distance from the image side of the fifth lens L5 to the object side of the glass plate GF.
d11: The center thickness of the glass plate GF.
d12: The axial distance from the image side to the imaging plane of the glass plate GF.
nd: Refractive power of d line.
nd1: Refractive power of d line of the first lens L1.
nd2: Refractive power of d line of the second lens L2.
nd3: Refractive power of d line of the third lens L3.
nd4: Refractive power of d line of the fourth lens L4.
nd5: Refractive power of d line of the fifth lens L5.
nd6: Refractive power of d line of glass plate GF.
v: Abbe number.
v1: Abbe number of the first lens L1.
v1: Abbe number of the second lens L2.
v3: Abbe number of the third lens L3.
v4: Abbe number of the fourth lens L4.
v5: Abbe number of the fifth lens L5.
v6: Abbe number of the glass plate GF.
TTL: Optical length (the axial distance from the object side to the imaging plane of the first lens L1).
LB: The axial distance from the image side to the imaging plane of the fifths lens L5 (including the thickness of the glass plate GF).
IH: Image height.

y=(x2/R)/[1+{1−(k+1)(x2/R2)}½]+A4×4+A6×6+A8×8+A10×10+A12×12+A14×14+A16×16 (10)

In which, R is the axial curvature radius. k is the cone constant. A4, A6, A8, A10, A12, A14, A16 are aspherical coefficient.

As a matter of convenience, the aspheric surface of all lenses is the aspheric surface in condition (10), but not limited to the polynomial of the aspheric surface in the condition (10).

### Embodiment 1

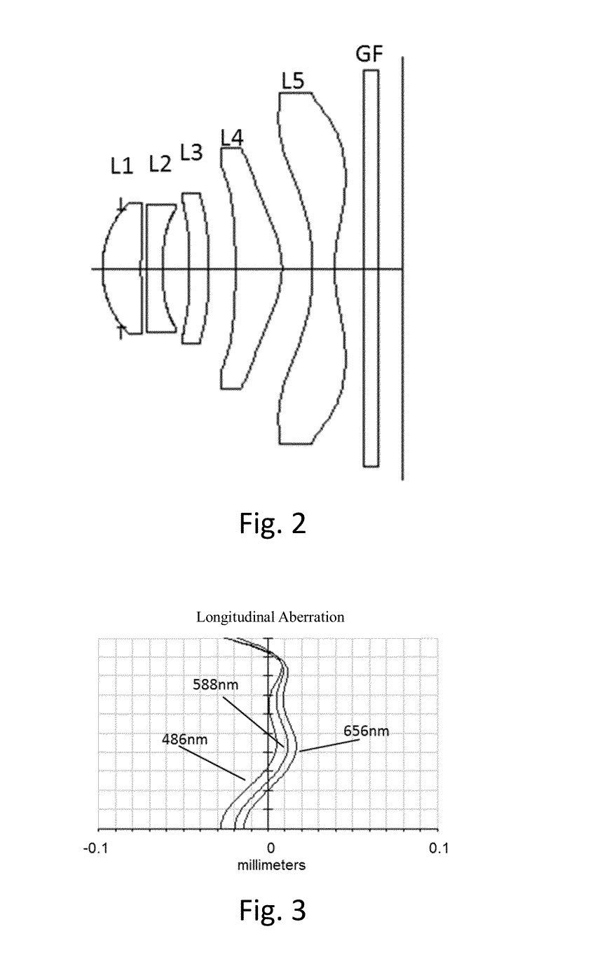

FIG. 2 is a structural diagram of the camera lens LA in the embodiment 1. Table 1 lists the curvature radius R of the object side and the image side of the first lens L1 to the fifth lens L5 of the camera lens LA in the embodiment 1, the center thickness of the lens and the distance d between lenses, the refractive power nd, Abbe number v. The cone constant k and aspherical coefficient are shown in table 2.

TABLE 1

| | R | d | | nd | | v d | |
|---|---|---|---|---|---|---|---|
| S1 | ∞ | d0 = | −0.290 | | | | |
| R1 | 1.36248 | d1 = | 0.544 | nd1 | 1.5441 | v 1 | 56.12 |
| R2 | 18.49211 | d2 = | 0.071 | | | | |
| R3 | 37.97228 | d3 = | 0.230 | nd2 | 1.6510 | v 2 | 21.51 |
| R4 | 3.11724 | d4 = | 0.373 | | | | |
| R5 | −35.06843 | d5 = | 0.267 | nd3 | 1.6510 | v 3 | 21.51 |
| R6 | −36.78302 | d6 = | 0.382 | | | | |
| R7 | −9.50309 | d7 = | 0.654 | nd4 | 1.5441 | v 4 | 56.12 |
| R8 | −1.22836 | d8 = | 0.429 | | | | |
| R9 | −3.63582 | d9 = | 0.307 | nd5 | 1.5441 | v 5 | 56.12 |
| R10 | 1.75573 | d10 = | 0.400 | | | | |
| R11 | ∞ | d11 = | 0.210 | nd6 | 1.5168 | v 6 | 64.17 |
| R12 | ∞ | d12 = | 0.336 | | | | |

TABLE 2

| | cone constant | aspherical coefficient | | | | | | |
|---|---|---|---|---|---|---|---|---|
| | k | A4 | A6 | A8 | A10 | A12 | A14 | A16 |
| R1 | 0.0000E+00 | 6.9615E−03 | 7.0597E−02 | −1.5241E−01 | 1.2483E−01 | −2.5553E−03 | −3.7806E−02 | 2.0158E−02 |
| R2 | 0.0000E+00 | 3.7847E−02 | −6.2654E−02 | 1.2054E−01 | −1.3927E−01 | −5.7143E−02 | −6.0458E−02 | 1.3722E−01 |
| R3 | 0.0000E+00 | 4.4838E−02 | 1.7077E−02 | −1.0483E−02 | −3.4262E−02 | −6.8339E−02 | −1.4259E−01 | 1.0512E−01 |
| R4 | 7.2966E+00 | 7.1747E−02 | 1.3961E−02 | 1.2143E−01 | −1.6765E−01 | −1.3706E−01 | 5.6163E−01 | −3.6862E−01 |
| R5 | 0.0000E+00 | −1.6021E−01 | 5.2240E−02 | −9.2801E−02 | 1.0302E−01 | 1.1157E−01 | 3.7691E−02 | −1.4499E−01 |
| R6 | 0.0000E+00 | −1.3256E−01 | 1.6005E−02 | −3.1547E−02 | 2.1063E−02 | 3.6596E−02 | 3.6618E−02 | −3.7216E−02 |
| R7 | 1.2377E+01 | −4.9618E−03 | 2.6403E−02 | −4.4789E−02 | 1.5007E−02 | 7.3903E−04 | −5.8162E−04 | −2.4118E−06 |
| R8 | −4.7890E+00 | −8.7518E−02 | 1.3961E−01 | −8.0813E−02 | 2.2218E−02 | −2.7041E−03 | 3.0819E−05 | 1.5280E−05 |
| R9 | 0.0000E+00 | −4.2773E−02 | 1.9548E−02 | −1.9537E−05 | −8.2309E−04 | 9.0102E−05 | 6.6457E−06 | −1.0669E−06 |
| R10 | −1.0106E+01 | −7.1956E−02 | 2.6749E−02 | −7.8943E−03 | 1.3197E−03 | −1.0803E−04 | 8.4124E−07 | 3.7409E−07 |

Values shown in table 7 include: the values of the embodiments 1-3 and the corresponding values of the parameters specified in the condition expressions (1)-(9).

As shown in table 7, the embodiment 1 meets the conditions (1)-(9).

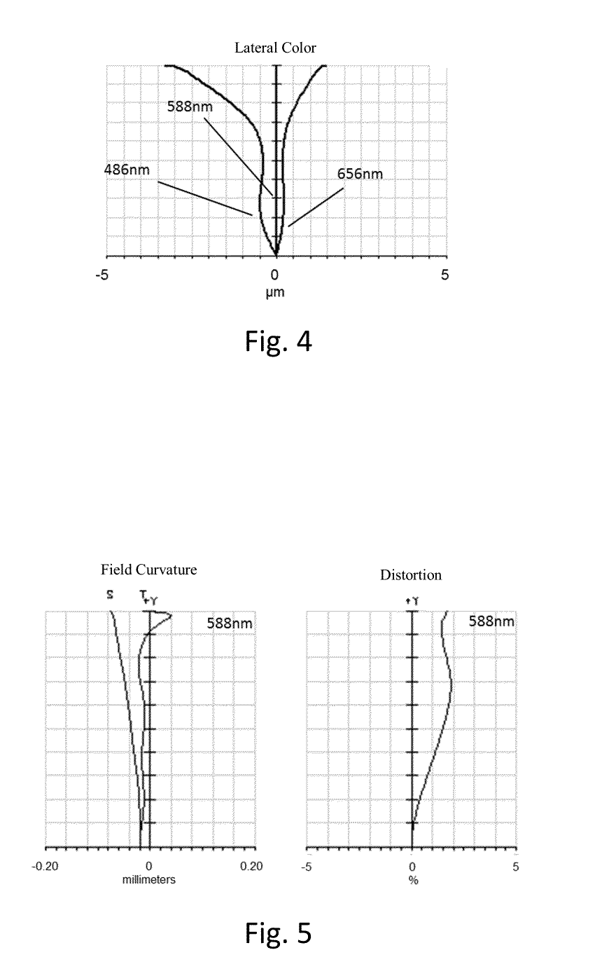

FIG. 3 shows the longitudinal aberration of the camera lens LA in the embodiment 1. FIG. 4 is the Lateral Color. FIG. 5 is the field curvature and distortion. In addition, the field curvature S in FIG. 5 is the field curvature relative to sagittal plane. T is the field curvature relative to the tangent imaging plane. It is same also in embodiment 2 and 3. In embodiment 1, the camera lens LA has 2 ω=78.7°, TTL/IH=1. 433, Fno=2.09 and the lenses are super thin and high-luminous flux wide angle lenses. As shown in FIGS. 3-5, it is easy to understand that the camera lens has excellent optical properties.

### Embodiment 2

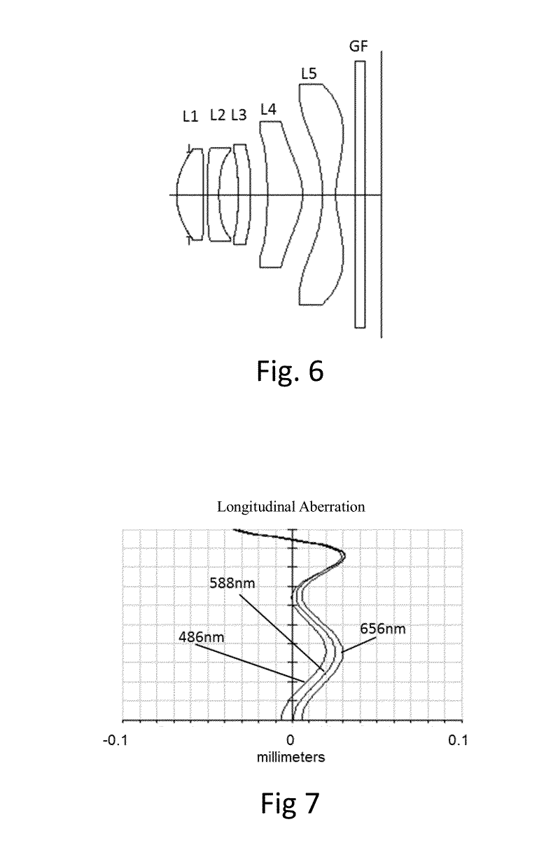

FIG. 6 is the structural diagram of the camera lens LA in the embodiment 2. The curvature radius R of the object side and the image side of the first lens L1 to the fifth lens L5 of the camera lens LA in embodiment, the center thickness of the lens and the distance d between lenses, refractive power nd, Abbe number v are shown in table 3. The cone constant k and aspherical coefficient are shown in table 4.

TABLE 3

| | R | d | | nd | | v d | |
|---|---|---|---|---|---|---|---|
| S1 | ∞ | d0 = | −0.290 | | | | |
| R1 | 1.41077 | d1 = | 0.560 | nd1 | 1.5441 | v 1 | 56.12 |
| R2 | 342.18996 | d2 = | 0.096 | | | | |
| R3 | −67.95345 | d3 = | 0.232 | nd2 | 1.6510 | v 2 | 21.51 |
| R4 | 3.41446 | d4 = | 0.394 | | | | |
| R5 | −74.38590 | d5 = | 0.261 | nd3 | 1.6510 | v 3 | 21.51 |
| R6 | −81.73282 | d6 = | 0.357 | | | | |
| R7 | −8.11649 | d7 = | 0.736 | nd4 | 1.5441 | v 4 | 56.12 |
| R8 | −1.22780 | d8 = | 0.416 | | | | |
| R9 | −3.53072 | d9 = | 0.280 | nd5 | 1.5441 | v 5 | 56.12 |
| R10 | 1.66088 | d10 = | 0.400 | | | | |
| R11 | ∞ | d11 = | 0.210 | nd6 | 1.5168 | v 6 | 64.17 |
| R12 | ∞ | d12 = | 0.342 | | | | |

TABLE 4

| | cone constant | aspherical coefficient | | | | | | |
|---|---|---|---|---|---|---|---|---|
| | k | A4 | A6 | A8 | A10 | A12 | A14 | A16 |
| R1 | 0.0000E+00 | −5.5564E−03 | 7.1616E−02 | −1.6469E−01 | 1.0194E−01 | −2.4720E−02 | −4.8575E−02 | 3.1878E−02 |
| R2 | 0.0000E+00 | 1.4077E−02 | −6.1770E−02 | 1.1129E−01 | −1.4822E−01 | −5.3524E−02 | −4.1377E−02 | 1.6908E−01 |
| R3 | 0.0000E+00 | 4.3397E−02 | 2.7873E−02 | 2.9252E−03 | −1.4689E−02 | −3.9113E−02 | −9.9843E−02 | 1.6329E−01 |
| R4 | 7.8330E+00 | 6.4929E−02 | 2.4403E−02 | 1.4220E−01 | −1.5455E−01 | −1.3416E−01 | 5.5764E−01 | −3.7600E−01 |
| R5 | 0.0000E+00 | −1.6372E−01 | 4.8133E−02 | −9.4160E−02 | 9.7990E−02 | 9.3463E−02 | 3.1230E−02 | −1.0033E−01 |
| R6 | 0.0000E+00 | −1.3243E−01 | 2.3146E−02 | −3.6280E−02 | 1.7362E−02 | 3.6627E−02 | 3.8241E−02 | −3.5599E−02 |
| R7 | 8.9186E+00 | 8.9130E−04 | 2.4330E−02 | −4.5090E−02 | 1.5013E−02 | 7.4688E−04 | −5.8379E−04 | −5.7689E−06 |
| R8 | −5.2852E+00 | −8.7952E−02 | 1.4066E−01 | −8.0344E−02 | 2.2309E−02 | −2.7190E−03 | 1.5598E−05 | 9.3194E−06 |
| R9 | 0.0000E+00 | −4.1105E−02 | 1.9617E−02 | −3.5958E−05 | −8.2901E−04 | 8.8738E−05 | 6.4092E−06 | −1.1054E−06 |
| R10 | −1.1515E+01 | −6.9915E−02 | 2.6442E−02 | −7.9239E−03 | 1.3160E−03 | −1.0861E−04 | 7.6163E−07 | 3.6681E−07 |

As shown in table 7, the embodiment 2 meets the conditions (1)-(9).

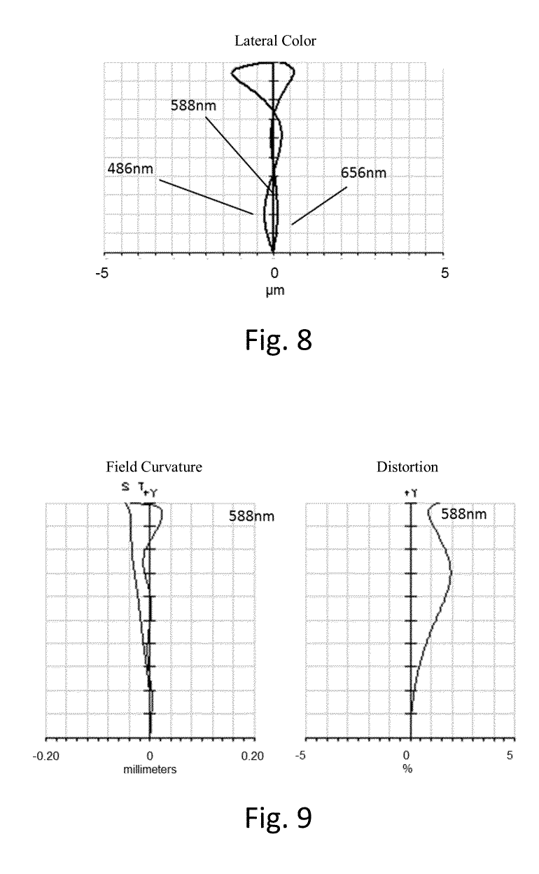

FIG. 7 shows the longitudinal aberration of the camera lens LA in the embodiment 2. FIG. 8 is the Lateral Color of the camera lens LA in the embodiment 2. FIG. 9 shows the field curvature and distortion of the camera lens LA in the embodiment 2. As shown in FIGS. 7-9, in the embodiment 2, the camera lens LA has TTL/IH-1.460, Fno=2.09, full image angle 2 ω=76.8°, and the lenses are ultrathin and high-luminous flux wide-angle lenses. It is easy to understand that the camera lens has excellent optical properties.

### Embodiment 3

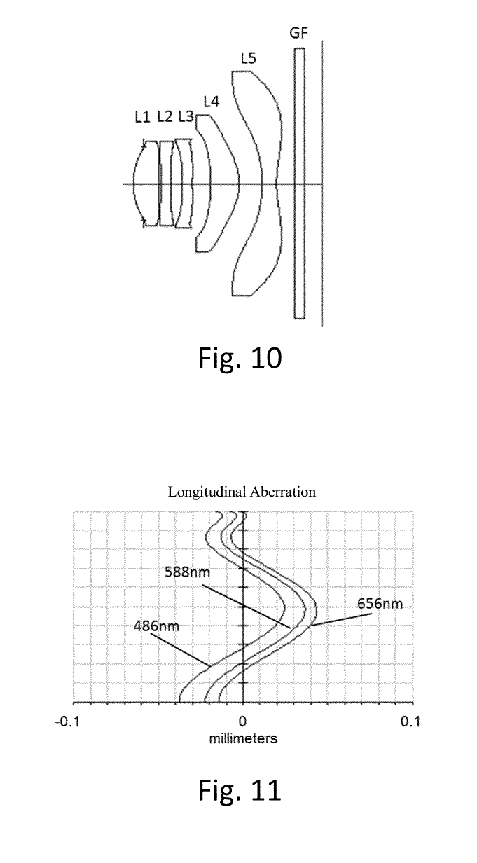

FIG. 10 is a structural diagram of the camera lens LA in the embodiment 3. The curvature radius R of the object side and the image side of the first lens L1 to the fifth lens, the center thickness of the lens and the distance d between lenses, refractive power nd, Abbe number v are shown in table 5. The cone constant k and aspherical coefficient are shown in table 6.

TABLE 5

| | R | d | | nd | | v d | |
|---|---|---|---|---|---|---|---|
| S1 | ∞ | d0 = | −0.220 | | | | |
| R1 | 1.41050 | d1 = | 0.566 | nd1 | 1.5441 | v 1 | 56.12 |
| R2 | 1830.14630 | d2 = | 0.042 | | | | |
| R3 | −4.48556 | d3 = | 0.203 | nd2 | 1.6397 | v 2 | 23.53 |
| R4 | 32.86580 | d4 = | 0.238 | | | | |
| R5 | 12.65217 | d5 = | 0.230 | nd3 | 1.6397 | v 3 | 23.53 |
| R6 | 11.61076 | d6 = | 0.400 | | | | |
| R7 | −3.72354 | d7 = | 0.620 | nd4 | 1.5441 | v 4 | 56.12 |
| R8 | −1.11939 | d8 = | 0.500 | | | | |
| R9 | −2.72669 | d9 = | 0.307 | nd5 | 1.5352 | v 5 | 56.12 |
| R10 | 2.08712 | d10 = | 0.400 | | | | |
| R11 | ∞ | d11 = | 0.210 | nd6 | 1.5168 | v 6 | 64.17 |
| R12 | ∞ | d12 = | 0.382 | | | | |

TABLE 6

| | cone constant | aspherical coefficient | | | | | | |
|---|---|---|---|---|---|---|---|---|
| | k | A4 | A6 | A8 | A10 | A12 | A14 | A16 |
| R1 | 3.3557E−03 | −1.8741E−02 | 3.6604E−02 | −8.7518E−02 | 2.8658E−04 | 7.7916E−03 | 9.6063E−03 | −9.5094E−02 |
| R2 | 0.0000E+00 | −3.6558E−02 | −2.3769E−02 | 8.4228E−02 | −1.2918E−01 | −1.1382E−01 | 9.4306E−03 | 7.1172E−02 |
| R3 | 0.0000E+00 | 8.1792E−02 | 6.7634E−02 | 8.3504E−03 | −3.8296E−02 | −7.8427E−02 | −6.5578E−02 | 1.6083E−01 |
| R4 | 1.7278E+02 | 7.7637E−02 | 2.0002E−02 | 6.5600E−04 | 7.6001E−02 | −1.2200E−01 | −7.7115E−02 | 7.3777E−02 |
| R5 | −1.0633E+03 | −2.5194E−01 | −4.3709E−02 | −7.3395E−02 | 6.6550E−02 | 2.5879E−01 | 1.8469E−01 | −3.6445E−01 |
| R6 | 1.0431E+02 | −1.9721E−01 | −3.6525E−02 | 3.5838E−02 | 5.4083E−02 | 3.7384E−02 | 3.6755E−02 | 2.6343E−02 |
| R7 | 7.4194E+00 | 2.2460E−02 | −1.0733E−02 | −3.0436E−02 | 5.4984E−03 | 2.9152E−03 | 6.1899E−04 | −1.0246E−03 |
| R8 | −3.4777E+00 | −7.1811E−02 | 8.2347E−02 | −3.6481E−02 | 7.2584E−03 | −5.3134E−04 | 3.2938E−04 | −2.3354E−04 |
| R9 | −3.0502E+00 | −4.5756E−02 | 1.2405E−02 | 7.3567E−04 | −2.3285E−04 | −7.6252E−06 | −6.0134E−06 | 1.3804E−06 |
| R10 | −1.7139E+01 | −6.0870E−02 | 1.7374E−02 | −4.1591E−03 | 5.1423E−04 | −3.1999E−05 | −5.7885E−07 | 2.5393E−07 |

As shown in table 7, the embodiment 3 meets the conditions (1)-(9).

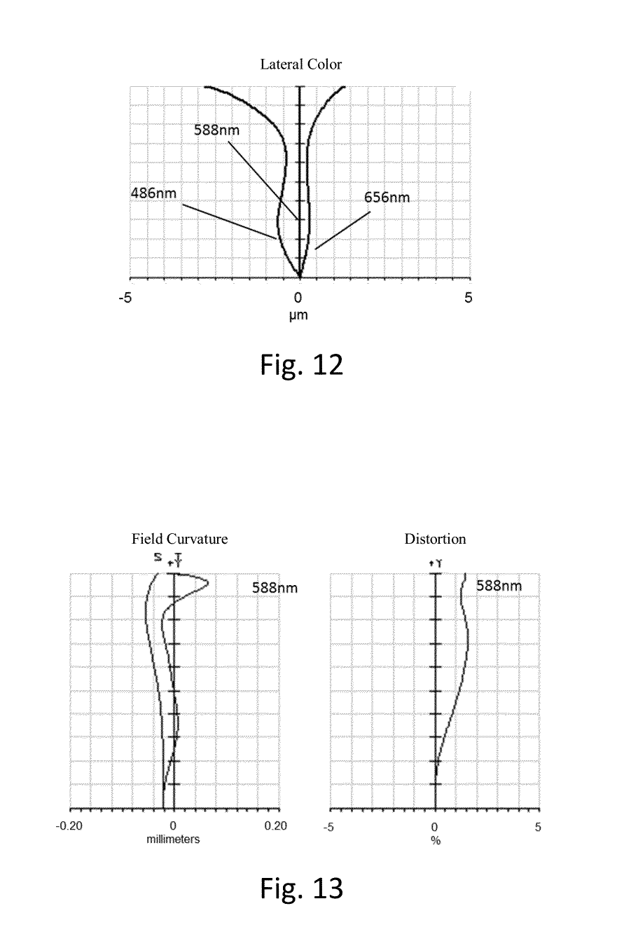

FIG. 11 shows the longitudinal aberration of the camera lens LA in the embodiment 3. FIG. 12 is the Lateral Color of the camera lens LA in the embodiment 3. FIG. 13 shows the field curvature and distortion of the camera lens LA in the embodiment 3. In embodiment 3, the camera lens LA has 2 ω=82.7°, TTL/IH=1.327, Fno=2.12 and the lenses are ultrathin, high-luminous flux wide-angle lenses. As shown in FIGS. 11-13, it is easy to understand that the camera lens has excellent optical properties.

The values of the embodiments and the corresponding values of the parameters specified in conditions (1)-(9) are listed in table 7. In addition, the units as shown in table 9 are respectively 2 ω (°), f (mm), f1 (mm), f2 (mm), f3 (mm), f4 (mm), f5 (mm), TTL (mm), LB (mm), IH (mm).

TABLE 7

| | Embodiment | Embodiment | Embodiment | |
|---|---|---|---|---|
| | 1 | 2 | 3 | Condition |
| f1/f | 0.766 | 0.713 | 0.758 | 1 |
| f2/f | −1.499 | −1.367 | −1.798 | 2 |
| f3/f | −352.911 | −353.231 | −70.469 | 3 |
| (R1 + R2)/ | −1.159 | −1.008 | −1.002 | 4 |
| (R1 − R2) | | | | |
| (R7 + R8)/ | 1.297 | 1.356 | 1.860 | 5 |
| (R7 − R8) | | | | |
| d6/f | 0.109 | 0.098 | 0.117 | 6 |
| d8/f | 0.123 | 0.114 | 0.146 | 7 |
| f4/f | 0.723 | 0.702 | 0.793 | 8 |
| f5/f | −0.611 | −0.558 | −0.631 | 9 |
| Fno | 2.09 | 2.09 | 2.12 | |
| 2ω | 78.7 | 76.8 | 82.7 | |
| TT/IH | 1.433 | 1.460 | 1.327 | |
| f | 3.489 | 3.650 | 3.424 | |
| f1 | 2.673 | 2.602 | 2.594 | |
| f2 | −5.231 | −4.988 | −6.157 | |
| f3 | −1231.306 | −1289.292 | −241.286 | |
| f4 | 2.522 | 2.562 | 2.714 | |
| f5 | −2.133 | −2.037 | −2.161 | |
| TTL | 4.203 | 4.284 | 4.098 | |
| LB | 0.946 | 0.952 | 0.992 | |
| IH | 2.934 | 2.934 | 3.088 | |

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A camera lens comprising, lined up in turn from an object side:
a stop;
a first lens with positive refractive power;
a second lens with negative refractive power;
a third lens with negative refractive power;
a fourth lens with positive refractive power;
a fifth lens with negative refractive power; wherein the camera lens satisfies the following conditions (1)-(6):
0.70≦f1/f≦0.78 (1)
−1.90≦f2/f≦−1.30 (2)
−400.00≦f3/f≦−65.00 (3)
−1.20≦(R1+R2)/(R1−R2)≦−1.00 (4)
−1.20≦(R7+R8)/(R7−R8)≦1.90 (5)
0.08≦d6/f≦0.13 (6)
where
f: Overall focal distance of the lenses.
f1: The focal distance of the first lens,
f2: The focal distance of the second lens,
f3: The focal distance of the third lens,
R1: The curvature radius of the object side of the second lens,
R2: The curvature radius of the image side of the first lens,
R7: The curvature radius of the object side of the fourth lens,
R8: The curvature radius of the image side of the fourth lens,
d6: The axial distance from the image side of the third lens to the object side of the fourth lens.

2. The camera lens as described in claim 1 further satisfying the following condition:
0.07≦d8/f≦0.15 (7)
where
f: Overall focal distance of the lenses,
d8: The axial distance from the image side of the fourth lens to the object side of the fifth lens.

3. The camera lens as described in claim 1 further satisfying the following condition (8):
0.50≦f4/f≦0.80 (8)
where
f: Overall focal distance of the lenses,
f4: The focal distance of the fourth lens.

4. The camera lens as described in claim 1 further satisfying the following condition (9):
−0.80≦f5/f≦−0.45 (9)
where
f: Overall focal distance of the lenses,
f5: The focal distance of the fifth lens.
